(19) United States
(12) Patent Application Publication
(10) Pub. No.: US 2014/0227334 A1
(43) Pub. Date: Aug. 14, 2014

(54) SELF ADHESIVE COPPER OR COPPER ALLOY PUSH PLATE

(71) Applicant: Libertas Copper, LLC d.b.a. Hussey Copper, Leetsdale, PA (US)

(72) Inventors: Joseph MALLAK, Chagrin Falls, OH (US); John R. LINTON, JR., Cranberry Township, PA (US); Stephanie BRICKNER, Jefferson Hills, PA (US)

(73) Assignee: Libertas Copper, LLC d.b.a. Hussey Copper, Leetsdale, PA (US)

(21) Appl. No.: 14/171,372

(22) Filed: Feb. 3, 2014

Related U.S. Application Data
(60) Provisional application No. 61/762,629, filed on Feb. 8, 2013.

(51) Int. Cl. A01N 59/20

(52) U.S. Cl. CPC A01N 59/20
USPC 424/411; 424/630; 156/60

(57) ABSTRACT

An antimicrobial self-adhesive push plate is disclosed. The push plate includes a copper or copper ahoy. The copper or copper alloy may include a minimum of 60% copper. The copper or copper alloy may also include a MD-Cu₂₉ antimicrobial copper or copper alloy.

### CROSS REFERENCE TO PRIOR APPLICATION

This application claims priority to and the benefit thereof from U.S. provisional patent application No. 61/762,629, filed Feb. 8, 2013, titled “Self Adhesive Copper or Copper Alloy Push Plate,” the entirety of which is hereby incorporated herein by reference.

### FIELD OF THE INVENTION

The invention relates generally to a push plate, and more specifically it relates to an antimicrobial self-adhesive push plate.

### BACKGROUND OF THE INVENTION

Currently, there exists large variety of strains of antibiotic resistant virulent microbes. The microbes cause diseases such as methicillin-resistant staphylococcus aureus (MRSA), that, if left untreated, can lead to sickness and even death. This problem is especially prevalent in settings e.g., hospital, public schools, elderly homes, and the like, where virulent microbes can easily spread among its inhabitants. There is almost a constant need to sanitize and/or disinfect surfaces where many people may come into physical contact with, One of these high contact surface areas includes push plates,

There are several types of antimicrobial agents that are currently applied to push plates and their surrounding for which antimicrobial protection is needed. They include chemical antimicrobial agents e.g., disinfectants. However, these chemical antimicrobial agents are often harmful to both the environment and the person coming into contact with them. Also, many of them can lose their antimicrobial activity within a short time period. There is also silver-based antimicrobial agent that may be used in forming push plates. However, silver-containing microbial agents are often expensive and therefore may not work for certain type of light switches. There is an unfulfilled need for a novel mechanism that protects push plates from antimicrobial agents.

### SUMMARY OF THE INVENTION

Accordingly, one aspect of the present disclosure provides an antimicrobial self-adhesive push plate. The push plate includes a copper or copper alloy. The copper or copper alloy may include a minimum of 60% copper.

The copper or copper alloy may include a MD-Cu₂₉ antimicrobial copper or copper alloy.

The push plate may include a layer of copper of copper alloy including a minimum of 60% copper.

The push plate may include a thickness that ranges from about 0.010 inches to about 0.125 inches.

The plate may include a thickness that is less than 0.010 inches.

The push plate may include a thickness that is greater than 0.125 inches.

The push plate may include a width that ranges from about 3.0 inches to 17.0 inches.

The push plate may include a width that is less than 3.0 inches.

The push plate may include a width that is greater than 17.0 inches.

The push plate may include a length that ranges from about 8.0 inches to about 36.0 inches.

The push plate may include a length that is less than 8.0 inches.

The push plate may include a length that is greater than 36.0 inches.

In one aspect, a method for disinfecting or killing bacteria is disclosed. The method includes affixing a push plate to a contact area, wherein the push plate includes copper or copper alloy containing a minimum of 60% copper.

The push plate may include MD-Cu₂₉ antimicrobial copper or copper alloy.

The method may further include applying at least one coat layer of adhesive to one side of a push plate and/or the contact area to adhere the push plate onto a location.

In one aspect, a method for disinfecting or killing bacteria is disclosed. The method includes applying a copper containing a minimum of 60% copper or antimicrobial copper onto a location that attaches to a push plate.

The method may include loading a material comprising at least 60% copper or antimicrobial copper on a reel, feeding the material to a forming device, applying an adhesive to a surface on one side of the material; and forming the material into a finished size blank.

The method may include applying a barrier layer to the adhesive layer, which may be carried out before or after the material is formed into the finished size blank.

The method may further include applying a barrier layer and the adhesive layer in a single step, which may be carried out before or after the material is formed into the finished size blank.

The method may also include applying the adhesive as the material is unrolled from the reel.

The method may include applying the adhesive as the material travels to a forming device.

The method may further include applying the adhesive after the finished sized blanks are formed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a push plate constructed according to the principles of the disclosure.

FIG. 2 shows an example of a push plate affixed to a door, according to principles of the disclosure.

FIG. 3 shows an example of a front perspective view of a push plate affixed to a door, according to principles of the disclosure.

FIG. 4 shows another example of a push plate affixed to a door, according to the principles of the disclosure.

FIG. 5 shows a process of making a push plate, according to the principles of the disclosure.

The present invention is further described in the detailed description that follows.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following attached description, It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

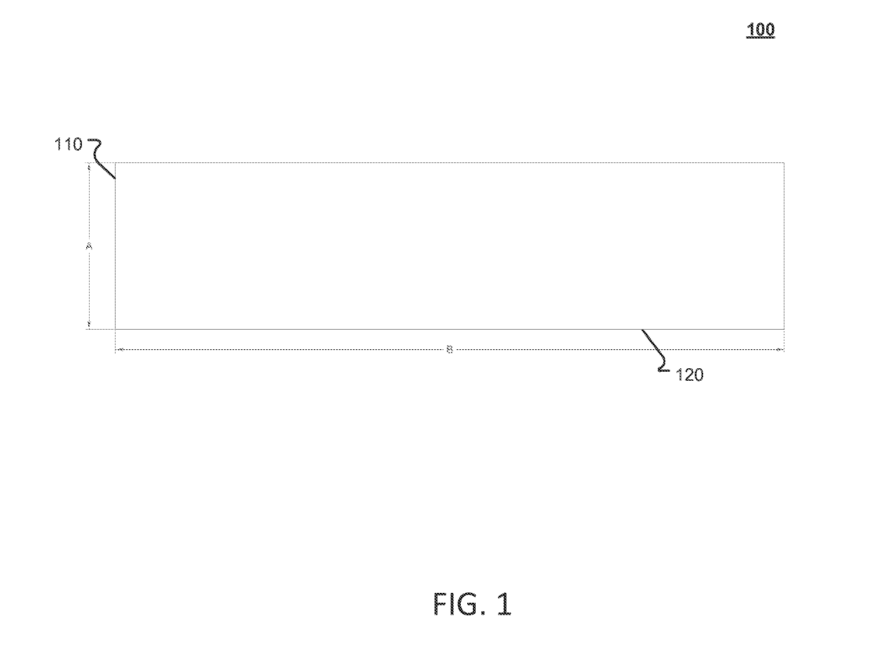

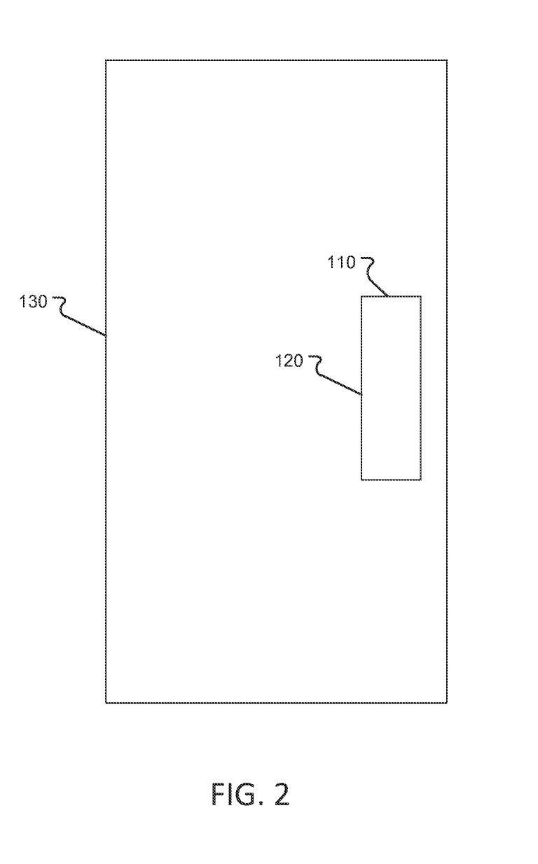

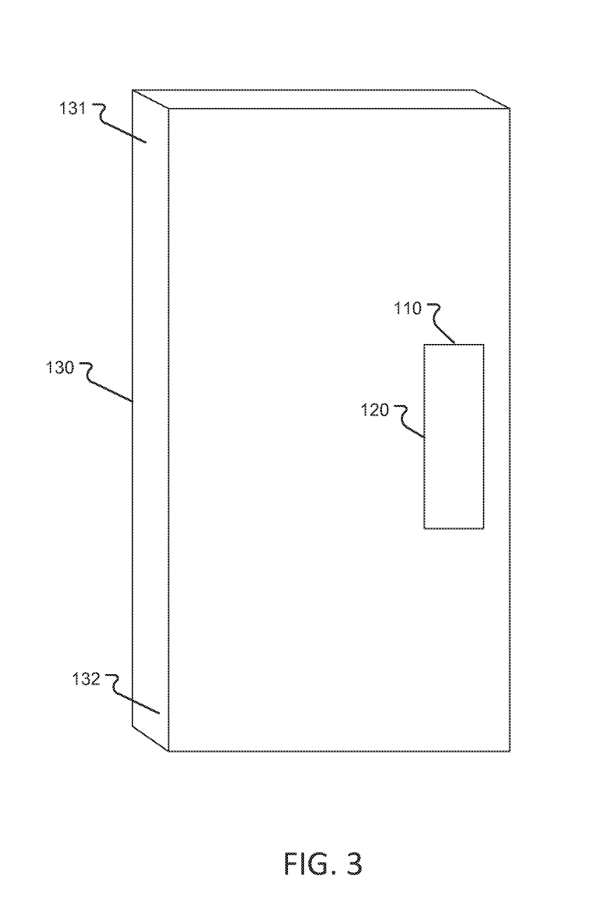

FIG. 1 shows a push plate configured according to principles of the disclosure. FIGS. 2 and 3 show an example of a push plate affixed to a door, configured according to principles of the disclosure. The push plate 100 may comprise a self-adhesive copper or copper alloy, or the push plate 100 may include a layer of self-adhesive copper or copper alloy. The push plate 100 may also comprise copper or copper alloy containing a minimum of 60% copper. For instance, the push plate 100 may comprise 70%, 80%, 90%, 100%, of copper or copper alloy, or any other percentage that is equal to or greater than 60% copper. The push plate 100 may further comprise MD-Cu₂₉ antimicrobial copper or copper alloy. The antimicrobial copper or copper alloy should effectively kill bacteria within about two hours of exposure to the bacteria. The antimicrobial copper or copper alloy may kill about 99.9% of bacteria within about two hours of contacting (or being infected by) the bacteria. If scratched, the area where scratched will remain antimicrobial.

Referring to FIGS. 1-3, the push plate 100 may include a width 110 and a length 120. The push plate 100 may be contacted by (e.g., a patient, a doctor, a visitor, a janitor, and so on) to open a door 13.

As shown, the push plate 100 may be configured to be placed over or on the door 130. The push plate 100 may comprise an adhesive layer that is provided on a portion of, or the entire surface of one side of the push plate 100. This provides antimicrobial protection for anyone coming in contact with the push plate 100 when passing through the door 130. The push plate 100 may further comprise a barrier layer, such as, e.g., a plastic, that is affixed to the adhesive layer. The barrier layer may be removed (e.g., peeled away) from the push plate 100 to expose the adhesive layer, which may then be used to adhere the push plate 100 to a surface, such as, a portion of, e.g., a door, a window, a furniture item, an appliance, or the like.

The push plate 100 may also include an adhesive on one side (e.g., glue, a bond, a tape, and so on) of the push plate 100 which can be used to attach to e.g., a door, a window, an appliance, a furniture item, a consumer product, or the like. The push plate 100 may also be attached to the door 130 via fastening mechanism e.g., a fastener, a clamp, a screw, and the like.

In one aspect, the door 130 may also comprise a copper or copper alloy with at least 60% copper. The door 130 may also include MD-Cu₂₉ antimicrobial copper or copper alloy. Alternatively, the copper, copper alloy, or MD-C may be applied to the unfilled space 28 which can be e.g., a plastic, a carbon fiber, a ceramic, a glass, and the like.

The door 130 may be attached to the, for example, a wall, corridor, furniture, and so on through a door hinge. The hinge may be attached onto the bottom of the door 132 and the top portion of the door 131. Alternatively, the door 130 may be attached to the wall with an adhesive (e.g., glue).

The push plate 100 may comprise a material having a temper that may range from soft to hard.

The push plate 100 may have a thickness that may range, for example, from about 0.010 inches to about 0.125 inches. The push plate 100 may also have a thickness that is less than 0.010 inches or greater than 0.125 inches. The thickness may be determined based on, e.g., customer specifications, customer requests, application demands, or the like, and may vary.

The push plate 100 may have a width of, e.g., about 3.0 inches to about 17.0 inches. The push plate 100 may have a width of less than 3.0 inches, or a width greater than 17.0 inches. The width may be determined based on, e.g., customer specifications, customer requests, application demands, or the like, and may vary.

The push plate 100 may have a length of, e.g., about 8.0 inches to about 36.0 inches. The push plate may have a length of less than 8.0 inches, or a length greater than 36.0 inches. The length may be determined based on, e.g., customer specifications, customer requests, application demands, or the like, and may vary.

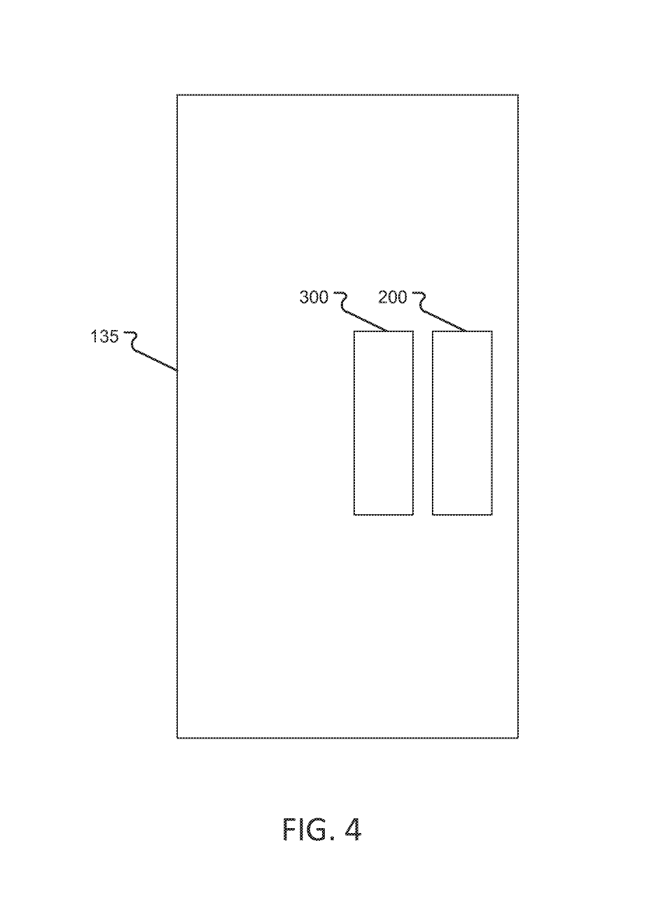

FIG. 4 shows another example of a push plate affixed to a door, according to the principles of the disclosure. As shown, there may be multiple (e.g., more than one) push plates attached to e.g., a door, a window, an appliance, a furniture item, a consumer product, or the like. The push plates 200 and 300 may comprise a self-adhesive copper or copper alloy. The push plates 200 and 300 may also comprise copper or copper alloy containing a minimum of 60% copper. For instance, the push plates 200 and 300 may comprise 70%, 80%, 90%, 100%, of copper or copper alloy, or any other percentage that is equal to or greater than 60% copper. The push plates 200 and 300 may further comprise MD-Cu₂₉ antimicrobial copper or copper alloy. The push plates 200 and 300 may comprise a material having a temper that may range from soft to hard. The thickness, width, and length of the push plates 200 and 300 may be similar to a push plate 100 (as shown in FIG. 1).

The push plates 200 and 300 may comprise an adhesive layer that is provided on a portion of, or the entire surface of one side of the push plate. The push plates 200 and 300 may further comprise a barrier layer, such as, e.g., a plastic, that is affixed to the adhesive layer. The barrier layer may be removed (e.g., peeled away) from the push plate to expose the adhesive layer, which may then be used to adhere the push plate to a surface, such as, a portion of, e.g., a door, a window, a furniture item, an appliance, or the like.

The push plates 200 and 300 may also include an adhesive on one side (e.g., a glue, a bond, a tape, and so on) which can be used to attach to e.g., a door, a window, an appliance, a furniture item, a consumer product, or the like. The push plate 200 and 300 may also be attached to the door 135 via fastening mechanism e.g., a fastener, a damp, a screw, and the like.

The door 135 may also include a copper or copper alloy with at least 60% copper. The door 135 may also include MD-Cu₂₉ antimicrobial copper or copper ahoy. Alternatively, the copper, copper alloy, or MD-Cu₂₉ may be applied to the unfilled space 28 which can be e.g., a plastic, a carbon fiber, a ceramic, a glass, and the like,

The door 135 may be attached to the, for example, a wall, corridor, furniture, and so on through a door hinge. The hinge may be attached onto the bottom-side of the door 135 and the top-side of the door 135. Alternatively, the door 135 may be attached to the wall with an adhesive (e.g., glue).

According an aspect of the invention, a method is provided for disinfecting or killing bacteria in areas that may involve contact with the bacteria. The method comprises providing a push plate to a location; affixing the push plate to a contact area on, for example, a door, a window, an appliance, a furniture item, a consumer product, or the like, wherein the push plate comprises copper or copper alloy containing a minimum of 60% copper. The push plate may comprise MD-Cu₂₉ antimicrobial copper or copper alloy. The antimicrobial copper or copper alloy should effectively kill many species of bacteria within, for example, about two hours, or less (or more) of contact with the bacteria. The contact area to which the push plate may be affixed may be a location on, e.g., the door, the window, or the lice, that is likely to be contacted (or touched) by a person, such as, e.g., a person entering a hospital room, a person entering (or exiting) a bathroom, a person entering exiting any public space through a door, and the like. The area which the push plate may be affixed (e.g., a door, window, or the like) may also include antimicrobial copper or copper alloy.

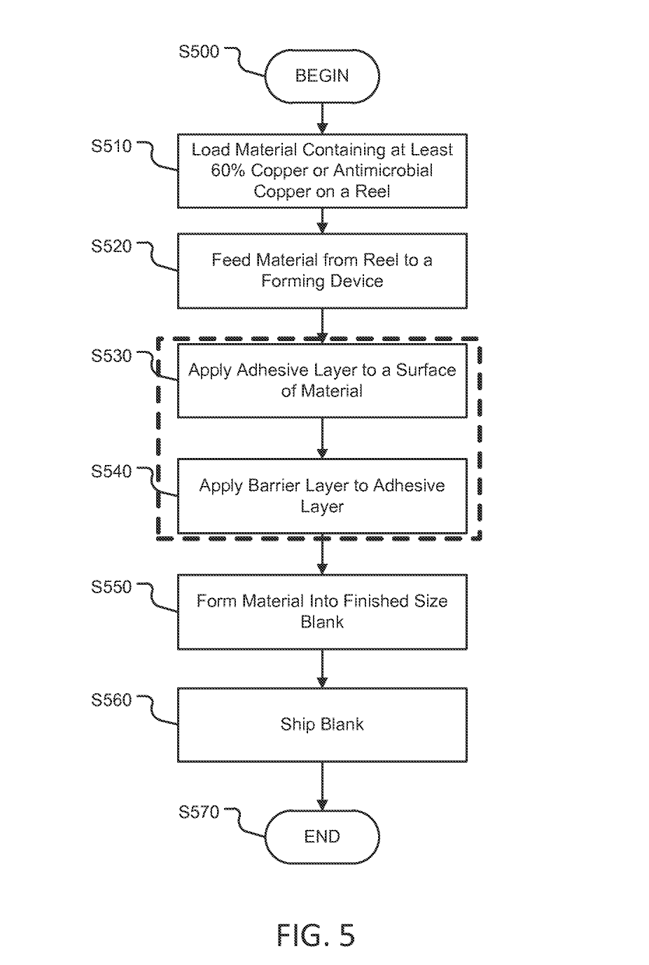

FIG. 5 shows an example of a process for manufacturing a push plate according to the principles of the invention. The process comprises: loading a material comprising at least 60% copper or antimicrobial copper on a reel (Step 510); feeding the material to a forming device (Step 520); applying an adhesive layer to a surface on one side (e.g., top side) of the material (Step 530); and forming the material into a finished size blank (Step 550). The applying an adhesive layer may include applying the adhesive as the material is unrolled from the reel, or further downstream as the material travels to the punch press. The step of applying the adhesive layer may be done after the finished size blanks are formed (e.g., stamped, cut, or the like).

The forming device (not shown) may comprise e.g., a punch press, an abrasive waterjet, a manual shearing apparatus (e.g., scissors, or the like), or the like.

The process may further include a step of applying a barrier ayer to the adhesive layer, which may be carried out before (or after) the material is formed into the finished size blank (Step 540).

In one application, the adhesive layer may be provided together with the barrier layer and the adhesive with barrier layer (or adhesive-barrier film) may be applied in a single step (as seen in Steps 530 and 540 in broken lines in FIG. 5) to the material. In this regard, the adhesive-barrier film may be rolled off a roll (not shown) and applied onto to the material (or finished plate). The exposed adhesive side of the adhesive-barrier film will adhere to the material (or finished plate) and the other side of the adhesive-barrier film will expose the barrier layer that may be peeled off, e.g., by the consumer at the time of installation.

The adhesive layer may comprise any one or more adhesives available on the market for adhering a metal to, e.g., a metal, a wood, a plastic, a painted item, or any other surface, as is known by those skilled in the art.

The barrier layer may comprise, e.g., a plastic film, or the like.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A push plate comprsng copper or copper alloy.

2. The push plate according to claim 1 wherein the copper or copper alloy comprises a minimum of 60% copper.

3. The push plate according to claim 1, wherein the copper or copper alloy comprises a MD-Cu₂₉ antimicrobial copper or copper alloy.

4. The push plate according to claim 1, wherein the push plate comprises a layer of copper or copper alloy comprises a minimum of 60% copper.

5. The push plate according to claim 1, wherein the push plate comprises a thickness that ranges from about 0.010 inches to about 0.125 inches

6. The push plate according to claim 1, wherein the push plate comprises a thickness that is less than 0.010 inches.

7. The push plate according to claim 1, wherein the push plate comprises a thickness that is greater than 0.125 inches.

8. The push plate according to claim 1, wherein the push plate comprises a width that ranges from about 3.0 inches to 17.0 inches.

9. The push plate according to claim 1, wherein the push plate comprises a width that is less than 3.0 inches.

10. The push plate according to claim 1, wherein the push plate comprises a width that is greater than 17.0 inches.

11. The push plate according to claim 1, wherein the push plate comprises a length that ranges from about 8.0 inches to about 36.0 inches.

12. The push plate according to claim 1, wherein the push plate comprises a length that is less than 8.0 inches.

13. The push plate according to claim 1, wherein the push plate comprises a length that is greater than 36.0 inches.

14. A method for disinfecting or killing bacteria comprising:
affixing a push plate to a contact area,
wherein the push plate comprises copper or copper alloy containing a minimum of 60% copper.

15. The method according to claim 14 wherein the push plate comprises MD-Cu₂₉ antimicrobial copper or copper alloy.

16. The method according to claim 14 further comprising:
applying at least one coat layer of adhesive to one side of a push plate and/or the contact area to adhere the push plate onto a location.

17. A method for disinfecting or killing bacteria comprising:
applying a copper containing a minimum of 60% copper or antimicrobial copper onto a location that attaches to a push plate.

18. A method for manufacturing a push plate comprising:
loading a material comprising at least 60% copper or antimicrobial copper on a reel;
feeding the material to a forming device;
applying an adhesive to a surface on one side of the material; and
forming the material into a finished size blank.

19. The method for manufacturing a push plate according to claim 18 further comprising:
applying a barrier layer to the adhesive layer, which may be carried out before or after the material is formed into the finished size blank.

20. The method for manufacturing a push plate according to claim 18 further comprising:
applying a barrier layer and the adhesive layer in a single step, which may be carried out before or after the material is formed into the finished size blank.

21. The method for manufacturing a push plate according to claim 18 wherein applying the adhesive further comprises:
applying the adhesive as the material is unrolled from the reel.

22. The method for manufacturing a push plate according to claim 18 wherein
applying the adhesive further comprises:
applying the adhesive as the material travels to a forming device.

23. The method for manufacturing a push plate according to claim 18 wherein applying the adhesive further comprises:
applying the adhesive after the finished sized blanks are formed.
